(19) United States
(12) Patent Application Publication
(10) Pub. No.: US 2007/0292722 A1
(43) Pub. Date: Dec. 20, 2007

(54) Magnetic recording medium and method of manufacturing the same

(75) Inventors: Kenichi Nakamura, Kanagawa (JP); Yohei Aritoshi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/798,236

(22) Filed: May 11, 2007

(30) Foreign Application Priority Data
May 12, 2006 (JP) 2006-134350

(51) Int. Cl. G11B 5/66; B05D 3/02; G11B 5/706

(52) U.S. Cl. 428/831; 427/372.2; 428/846

(57) ABSTRACT

Provided is a magnetic recording medium and method of manufacturing the same. The magnetic recording medium is formed by coating a nonmagnetic layer coating liquid on the nonmagnetic support and drying the nonmagnetic layer coating liquid to form the nonmagnetic layer, followed by coating a magnetic layer coating liquid on the nonmagnetic layer and drying the magnetic layer coating liquid to form the magnetic layer, and the magnetic layer comprises a ferromagnetic powder and a binder and the binder comprises a binder component comprising a constituent component in the form of a resin having a weight average molecular weight, Mw, of equal to or greater than 120,000.

### CROSS-REFERENCE TO RELATED APPLICATIONS

This application claims benefit of priority under 35 USC 119 to Japanese Patent Application No. 2006-134350 filed on May 12, 2006, which is expressly incorporated herein by reference in its entirety.

### BACKGROUND OF THE INVENTION

1. Field of the Invention

The present invention relates to a magnetic recording medium having good magnetic properties and a method of manufacturing the same. More particularly, the present invention relates to a magnetic recording medium having improved electromagnetic characteristics and an improved yield with excellent productivity, and a method of manufacturing the same.

2. Discussion of the Background

The digitization of magnetic recording media has progressed in recent years to improve signals that deteriorate due to repeated copying. As this has occurred, the increase in the amount of recorded data has necessitated the development of high-density recording media. In order to increase the recording density, the thickness loss and self-demagnetization loss of the medium must be taken into account, and it is desirable to reduce the thickness of the magnetic layer.

However, when the thickness of the magnetic layer is reduced, the surface properties of the nonmagnetic support affect the surface of the magnetic layer, and the electromagnetic characteristics deteriorate. In recent years, to inhibit the effects of the surface properties of nonmagnetic support, it has been proposed that a nonmagnetic layer in the form of a thermosetting resin, for example, be provided as an undercoating on the surface of the support, over which the magnetic layer is then positioned. For example, Japanese Unexamined Patent Publication (KOKAI) Showa Nos. 63-191315 and 63-191318, which are expressly incorporated herein by reference in their entirety, disclose methods for coating magnetic recording media of such multilayered structures by coating a nonmagnetic layer coating liquid, comprised of nonmagnetic particles dispersed in a thermosetting resin binder, on a nonmagnetic support, and while the nonmagnetic layer is still wet, coating a magnetic layer coating liquid thereover (also referred to as “simultaneous multilayer coating” hereinafter).

However, in methods in which a nonmagnetic layer and a magnetic layer are multilayer-coated while the coating liquids of the individual layers are still wet as set forth above, the nonmagnetic layer and magnetic layer intermix at the boundary. This intermixing at the boundary results in deterioration of electromagnetic characteristics and decreased yield, particularly when the magnetic layer is thinned.

By contrast, in methods in which a nonmagnetic layer coating liquid is first coated on a nonmagnetic support and dried to form a nonmagnetic layer, and a magnetic layer is subsequently formed on the nonmagnetic layer (also referred to as “successive multilayer coating” hereinafter), the resulting reduction in boundary intermixing of the nonmagnetic layer and magnetic layer effectively improves electromagnetic characteristics and the yield. Further, in such methods, the forming of a magnetic layer by coating a magnetic layer coating liquid of relatively low concentration on the nonmagnetic layer is an effective means of thinning the magnetic layer.

However, when a magnetic layer coating liquid of low concentration is coated over a nonmagnetic layer that has been coated and dried, and processing is conducted to orient ferromagnetic particles with magnets while the magnetic layer is still wet, the magnetic particles tend to aggregate (undergo orientation aggregation), which is another cause of deterioration in electromagnetic characteristics.

### SUMMARY OF THE INVENTION

A feature of the present invention provides for a magnetic recording medium with improved electromagnetic characteristics and yield.

A feature of the present invention further provides for a means for manufacturing such a magnetic recording medium economically and in large quantity.

A feature of the present invention relates to a magnetic recording medium comprising a nonmagnetic layer and a magnetic layer in this order on a nonmagnetic support, wherein

the magnetic recording medium is formed by coating a nonmagnetic layer coating liquid on the nonmagnetic support and drying the nonmagnetic layer coating liquid to form the nonmagnetic layer, followed by coating a magnetic layer coating liquid on the nonmagnetic layer and drying the magnetic layer coating liquid to form the magnetic layer, and

the magnetic layer comprises a ferromagnetic powder and a binder and the binder comprises a binder component comprising a constituent component in the form of a resin having a weight average molecular weight, Mw, of equal to or greater than 120,000.

In one embodiment, the binder component consists of the resin.

In one embodiment, the binder component is a reaction product of the resin and a compound comprising a thermosetting functional group.

In one embodiment, the binder component is a reaction product of the resin, a compound comprising a thermosetting functional group and other resin component.

In one embodiment, the magnetic layer has a thickness ranging from 10 to 300 nm.

In one embodiment, the magnetic layer comprises the resin in an amount of equal to or greater than 2.5 weight percent relative to the ferromagnetic powder.

In one embodiment, the resin is a polyurethane resin.

In one embodiment, the binder further comprises a vinyl chloride resin.

In one embodiment, the magnetic layer has a centerline average surface roughness, Ra, ranging from 1.0 to 10.0 nm.

A feature of the present invention further relates to a method of manufacturing a magnetic recording medium comprising:

coating a nonmagnetic layer coating liquid on a nonmagnetic support and drying the nonmagnetic layer coating liquid to form a nonmagnetic layer, followed by coating a magnetic layer coating liquid on the nonmagnetic layer and drying the magnetic layer coating liquid to form a magnetic layer, wherein

the magnetic layer coating liquid comprises a ferromagnetic powder and a binder and the binder comprises a resin having a weight average molecular weight, Mw, of equal to or greater than 120,000.

In one embodiment, orientation processing is conducted following coating of the magnetic layer coating liquid.

In one embodiment, the magnetic recording medium comprises the resin in an amount of equal to or greater than 2.5 weight percent relative to the ferromagnetic powder.

In one embodiment, the adsorption amount of the binder to the ferromagnetic powder in the magnetic layer coating liquid is equal to or greater than 80 mg per 1000 mg of the ferromagnetic powder.

In one embodiment, the solid component concentration of the magnetic layer coating liquid ranges from 5 to 25 weight percent.

In one embodiment, the coating of the magnetic layer coating liquid is conducted at a coating rate of equal to or higher than 100 m/min.

In one embodiment, the resin is a polyurethane resin.

In one embodiment, the binder further comprises a vinyl chloride resin.

In one embodiment, the binder further comprises a compound comprising a thermosetting functional group.

In one embodiment, the formation of the nonmagnetic layer and the magnetic layer is carried out sequentially on the nonmagnetic support that is fed from a nonmagnetic support stock roll, and following the formation of the nonmagnetic layer and magnetic layer, winding the nonmagnetic support to obtain a magnetic recording medium stock roll, and cutting part of the magnetic recording medium stock roll to obtain a magnetic recording medium in the form of a tape or disk.

In one embodiment, the formation of the nonmagnetic layer and magnetic layer is carried out on a continuously running nonmagnetic support,

the coating of the magnetic layer coating liquid is carried out by discharging the magnetic layer coating liquid that has been fed into a coating head from a coating slit of the coating head onto the nonmagnetic layer in a quantity in excess of the quantity required to form a magnetic layer of desired thickness while the nonmagnetic layer formed on the nonmagnetic support and a lip surface of the font end of the coating head are in a state of close proximity, and the magnetic layer coating liquid that has been coated in excess is picked up by aspiration through a recovery slit provided downstream from the coating slit as viewed in the running direction of the nonmagnetic support, as well as,

the aspiration is carried out so as to satisfy equation (I) below when the liquid pressure at the aspiration inlet of the recovery slit is denoted as P (MPa):
0.05>P≧0 (I)

In one embodiment, the magnetic layer has a thickness ranging from 10 to 300 nm.

In one embodiment, the magnetic layer has a centerline average surface roughness, Ra, ranging from 1.0 to 10.0 nm.

The present invention permits improvement in the aggregation (orientation aggregation) of ferromagnetic particles in the course of the orientation processing of the ferromagnetic particles, and thus provides a magnetic recording medium with improved electromagnetic characteristics and yield.

Further, the present invention permits the economical, large-quantity manufacturing of such a magnetic recording medium by continuously forming a nonmagnetic layer and a magnetic layer on a nonmagnetic support that is fed from a nonmagnetic support stock roll, and following the formation of the nonmagnetic layer and magnetic layer, winding the nonmagnetic support to obtain a magnetic recording medium stock roll, and cutting part of this roll to obtain a magnetic recording medium in the form of a tape or disk.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 shows an SEM photograph (Example 1-2) of the surface of a magnetic layer completely free of orientation aggregation.

FIG. 2 shows an SEM photograph (Example 1-1) of the surface of a magnetic layer with only slight orientation aggregation.

FIG. 3 shows an SEM photograph (Comparative Example 1-1) of the surface of a magnetic layer completely covered with marked orientation aggregation.

### DESCRIPTIONS OF THE EMBODIMENTS

The following preferred specific embodiments are, therefore, to be construed as merely illustrative, and not limitative of the remainder of the disclosure in any way whatsoever. In this regard, no attempt is made to show structural details of the present invention in more detail than is necessary for the fundamental understanding of the present invention, the description taken with the drawings making apparent to those skilled in the art how the several forms of the present invention may be embodied in practice.

Magnetic Recording Medium

The magnetic recording medium of the present invention comprises a nonmagnetic layer and a magnetic layer in this order on a nonmagnetic support. The magnetic recording medium is formed by coating a nonmagnetic layer coating liquid on the nonmagnetic support and drying the nonmagnetic layer coating liquid to form the nonmagnetic layer, followed by coating a magnetic layer coating liquid on the nonmagnetic layer and drying the magnetic layer coating liquid to form the magnetic layer, and the magnetic layer comprises a ferromagnetic powder and a binder and the binder comprises a binder component comprising a constituent component in the form of a resin having a weight average molecular weight, Mw, of equal to or greater than 120,000.

The magnetic recording medium of the present invention is formed (successively multilayer-coated) by coating a nonmagnetic layer coating liquid on the nonmagnetic support and drying the nonmagnetic layer coating liquid to form the nonmagnetic layer, followed by coating a magnetic layer coating liquid on the nonmagnetic layer and drying the magnetic layer coating liquid to form the magnetic layer.

As set forth above, in simultaneous multilayer coating, intermixing occurs at the boundary between the nonmagnetic layer and the magnetic layer. In magnetic recording media having a thin magnetic layer, in particular, this boundary intermixing causes the deterioration of electromagnetic characteristics and the yield. By contrast, since boundary intermixing is reduced in the formation of magnetic recording media by successive multilayer coating, it is possible to improve electromagnetic characteristics and the yield.

Since there is little intermixing between the nonmagnetic layer and the magnetic layer in magnetic recording media formed by successive multilayer coating, when the composition is analyzed by etching in a depthwise direction from the surface of the magnetic layer of a medium, a distinct difference in composition is observed at the boundary. By contrast, since intermixing occurs at the boundary between the nonmagnetic layer and the magnetic layer in magnetic recording media formed by simultaneous multilayer coating, this same analysis reveals no clear difference in composition at the boundary. Thus, a medium that has been formed by simultaneous multilayer coating can be clearly distinguished from a medium that has been formed by successive multilayer coating based on this difference.

Further, when magnetic layers of identical thickness are formed with an identical coating liquid in a medium formed by simultaneous multilayer coating and a medium formed by successive multilayer coating, the level of variation at the boundary between the nonmagnetic layer and the magnetic layer will be lower in the medium formed by successive multilayer coating than in the medium formed by simultaneous multilayer coating. Thus, based on the difference in boundary variation at the boundary between the nonmagnetic layer and the magnetic layer, it is possible to distinguish between a medium that has been formed by successive multilayer coating and a medium that has been formed by simultaneous multilayer coating. For example, the boundary variation at the boundary between the nonmagnetic layer and the magnetic layer in a tape medium can be measured by the following method.

The longitudinal cross-section of a magnetic recording medium (tape) is observed with a transmission electron microscope (TEM) at a magnification of about 100,000-fold. An epoxy resin is used to envelope the tape when cutting the cross-section. The cross-section is analyzed with an image analyzer over a length of about 10 micrometers, the thickness of the magnetic layer, d, and the standard deviation thereof, sigma, are calculated, and the boundary variation rate is calculated as (sigma/d)×100 (%).

For example, although depending on the formula of the magnetic layer coating liquid and the like, when the thickness of the magnetic layer is about 80 nm, a magnetic recording medium formed by simultaneous multilayer coating will have a boundary variation of about 30 to 45 percent, while a magnetic recording medium formed by successive multilayer coating will have a boundary variation of about 5 to 30 percent.

In the magnetic recording medium of the present invention, the binder in the magnetic layer contains a binder component comprising a resin with a weight average molecular weight (Mw) of equal to or greater than 120,000 as a constituent component. As stated above, when magnetic orientation processing is conducted following coating of the magnetic layer coating liquid, ferromagnetic powder particles sometimes aggregate (undergo orientation aggregation) in magnetic recording media formed by successive multilayer coating. This orientation aggregation is particularly marked when a low-concentration magnetic layer coating liquid is employed to form a thin magnetic layer. This is because the lower the concentration, the easier it becomes for the ferromagnetic powder particles to be displaced by magnetic forces during orientation processing.

To prevent the aforementioned orientation aggregation, it is conceivably possible to increase the adsorption amount of the binder to the ferromagnetic powder particles in the magnetic layer coating liquid. To that end, it is also conceivable to introduce numerous polar groups to a binder of low molecular weight. However, the introduction of numerous polar groups increases the hydrophilic property of the binder, which risks compromising environmental durability (in high humidity). It is also conceivable to increase the adsorption amount of the binder to the ferromagnetic powder particles by increasing the quantity of binder added to the magnetic layer coating liquid. However, the addition of a large quantity of binder decreases the ratio of ferromagnetic powder particles to binder in the magnetic layer, which is undesirable from the perspective of electromagnetic characteristics.

Accordingly, in the present invention, in order to reduce or prevent orientation aggregation, a binder component containing a constituent component in the form of a resin of higher molecular weight, a weight average molecular weight (Mw) of equal to or greater than 120,000, than the resin employed as binder in conventional magnetic recording media is employed in the magnetic layer. Since the resin having the above-stated molecular weight is highly adsorptive to ferromagnetic powder particles, the use of this resin as a component of the magnetic layer coating liquid permits an increase in the adsorption amount of the binder to ferromagnetic power particles in the magnetic layer coating liquid. Increasing the adsorption amount of the binder in this manner is thought to increase the stereorepulsion of the ferromagnetic powder particles in the magnetic layer coating liquid, thereby inhibiting orientation aggregation of the ferromagnetic powder particles during orientation processing.

The fact that the above resin is contained as a magnetic layer component can be confirmed by gel permeation chromatography (GPC) analysis of the binder in the magnetic layer, for example.

The above resin having a weight average molecular weight (Mw) of equal to or greater than 120,000 is not specifically limited other than that it possesses the stated molecular weight. However, from the perspectives of suitable microdispersion of ferromagnetic powder particles, suitable durability (suitability to ambient temperature and humidity), and the like, a polyurethane resin, polyester resin, or cellulose acetate is desirable, with polyurethane resin and polyester resin being preferred, and polyurethane resin being of even greater preference. The structure of the polyurethane resin is not specifically limited; any known polyurethane resin may be employed, such as polyester polyurethane, polyether polyurethane, polyether polyester polyurethane, polycarbonate polyurethane, polyester polycarbonate polyurethane, and polycaprolactone polyurethane. In the present invention, multiple resins having weight average molecular weights of 120,000 or more can be combined for use.

The weight average molecular weight (Mw) of the above resin is equal to or greater than 120,000. When the weight average molecular weight of the above resin is less than 120,000, adsorption to ferromagnetic powder particles is poor and it becomes difficult to increase the adsorption amount of the binder to ferromagnetic power particles in the magnetic layer coating liquid. In consideration of solubility and ease of synthesis, the weight average molecular weight of the above resin is desirably equal to or less than 500,000. The above weight average molecular weight is preferably 120,000 to 300,000, more preferably 150,000 to 250,000.

The above resin preferably has a glass transition temperature ranging from −50 to 150° C., more preferably 0 to 100° C., and further preferably, 30 to 90° C. The elongation at break is preferably 100 to 2,000 percent, the stress at break is preferably 0.05 to 10 kg/mm², approximately 0.49 to 98 MPa, and the yield point is preferably 0.05 to 10 kg/mm², approximately 0.49 to 98 MPa. The above resin can be synthesized by known methods, and is also commercially available.

The above binder component can consist of the above resin. That is, the above binder component can be the above resin. The above binder component can also be a reaction product of the above resin and a compound having a thermosetting functional group. The magnetic recording medium of the present invention is formed by forming a nonmagnetic layer on a nonmagnetic support and then coating and drying a magnetic layer coating liquid thereover. When a magnetic layer is formed by adding the above resin without adding a compound having a thermosetting functional group to the above magnetic layer coating liquid, a magnetic recording medium containing the above resin as the above binder component is obtained. Further, when a compound having a thermosetting functional group is added along with the above resin to the magnetic layer coating liquid, a curing reaction (crosslinking reaction) can be induced by heating (calendering, heating, or the like) following coating, yielding a magnetic recording medium containing the reaction product of the above resin and a compound having a thermosetting functional group as the above binder component. As set forth further below, when adding a resin component in addition to the above resin and compound having a thermosetting functional group to the magnetic layer coating liquid, a copolymer of the above resin, a compound containing a thermosetting functional group, and the additional resin component can be obtained.

The use of a component comprising a thermosetting functional group in the form of an isocyanate group as the above compound containing a thermosetting functional group is desirable. Of these, polyisocyanates are desirable. Isocyanates such as tolylene diisocyanate, 4,4′-diphenylmethane diisocyanate, hexamethylene diisocyanate, xylylene diisocyanate, naphthylene-1,5-diisocyanate, o-toluidene diisocyanate, isophorone diisocyanate, and triphenylmethane triisocyanate; products of these isocyanates and polyalcohols; and polyisocyanates produced by condensation of these isocyanates are suitable for use.

These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used singly or in combinations of two or more by exploiting differences in curing reactivity.

The above binder can contain other binder components in addition to the above-described binder component. Examples of other binder components that may be employed in combination with the above-described binder component are conventionally known thermoplastic resins, thermosetting resins, reactive resins, and mixtures thereof. The glass transition temperature of thermoplastic resins employed in combination is preferably −100 to 200° C., more preferably −50 to 150° C.

Specific examples of thermoplastic resins that can be employed in combination are polymers and copolymers containing structural units in the form of vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal, and vinyl ether; polyurethane resins, various rubber resins, and cellulose esters.

Examples of thermosetting resins and reactive resins that can be employed in combination are phenol resin, epoxy resin, polyurethane cured resin, urea resin, melamine resin, alkyd resin, acrylic reaction resin, formaldehyde resin, silicone resin, epoxy-polyamide resin, mixtures of polyester resin and isocyanate prepolymer, mixtures of polyester polyol and polyisocyanate, and mixtures of polyurethane and polyisocyanate. These resins are described in detail in the “Plastic Handbook” released by Asakura Shoten, which is expressly incorporated herein by reference in its entirety. Known e-beam-setting resins may also be employed in the various layers. Examples of such resins and their manufacturing methods are described in detail in Japanese Unexamined Patent Publication (KOKAI) Showa No. 62-256219, which is expressly incorporated herein by reference in its entirety.

The aforementioned resins may be employed singly or in combination. Preferred resins are combinations of polyurethane resin and at least one member selected from the group consisting of vinyl chloride resin, vinyl chloride-vinyl acetate copolymers, vinyl chloride-vinyl acetate-vinyl alcohol copolymers, and vinyl chloride vinyl acetate-maleic anhydride copolymers, as well as combinations of the same with polyisocyanate. Vinyl chloride resins are particularly preferred. Combining a vinyl chloride resin further increases dispersion of the ferromagnetic powder, and thus improves electromagnetic properties and effectively reduces soiling of the head.

To achieve better dispersion and durability in any of the binder components suitable for use in the magnetic layer, the use of a binder component in which one or more polar groups selected from the group consisting of —COOM, —SO₃M, —OSO₃M, —P═O(OM)₂, —O—P═O(OM)₂ (wherein M denotes a hydrogen atom or an alkali metal base), OH, NR₂, N⁺R₃ (wherein R denotes a hydrocarbon), epoxy group, SH, and CN has been introduced by copolymerization or addition reaction as needed can be employed. The quantity of the polar group is, for example, 10⁻¹ to 10⁻⁸ mole/g, preferably 10⁻² to 10⁻⁶ mole/g.

Specific examples of the binder components mentioned above are VAGH, VYHH, VMCH, VAGF, VAGD, VROH, VYES, VYNC, VMCC, XYHL, XYSG, PKHH, PKHJ, PKHC, and PKFE from Union Carbide Corporation; MPR-TA, MPR-TA5, MPR-TAL, MPWR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400×−110A from Nippon Zeon Co., Ltd.; Nippollan N2301, N₂₃O₂, and N₂₃O₄ from Nippon Polyurethane Co., Ltd.; Pandex T-5105, T-R3080, T-5201, Bumock D-400, D-2, 0-80, Crisvon 6109, and 7209 from Dainippon Ink and Chemicals Incorporated; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The magnetic layer of the magnetic recording medium of the present invention preferably comprises 2.5 weight percent of the above resin having a weight average molecular weight (Mw) of equal to or greater than 120,000 relative to the ferromagnetic powder. That is, the magnetic recording medium of the present invention is preferably formed using a magnetic layer coating liquid containing 2.5 weight percent or more of the above resin relative to the ferromagnetic powder. In the magnetic layer coating liquid containing 2.5 weight percent or more of the above resin relative to the ferromagnetic powder, the adsorption amount of the binder to ferromagnetic powder is high and orientation aggregation is effectively inhibited. The quantity of the resin in the magnetic layer is preferably 4 to 40 weight percent, more preferably 5 to 30 weight percent, and further preferably, 5 to 25 weight percent, of the ferromagnetic powder. Desirable contents of binder components employed in combination are given below.

The magnetic layer of the magnetic recording medium of the present invention has a thickness, for example, ranging from 10 to 300 nm, for example. In the present invention, the use of the resin having a weight average molecular weight (Mw) of equal to or greater than 120,000 in the magnetic layer prevents orientation aggregation during formation of a relatively thin magnetic layer having a thickness falling within the above-stated range by successive multilayer coating, thereby yielding a magnetic recording medium having good electromagnetic characteristics. The thickness of the magnetic layer is preferably 30 to 150 nm, more preferably 40 to 100 nm.

The electromagnetic characteristics are usually affected by the surface roughness of the magnetic layer of the magnetic recording medium; better electromagnetic characteristics can be achieved by smoothing the surface. The surface roughness affecting electromagnetic characteristics can be evaluated by atomic force microscopy (AFM). The lower the centerline average surface roughness (Ra) of the surface of the magnetic layer, the better. The centerline average surface roughness (Ra) of the magnetic layer is preferably 1.0 to 10.0 nm, more preferably 2.0 to 10.0 nm, further preferably 2.5 to 7.0 nm, and most preferably, 2.8 to 5.0 nm.

The centerline average surface roughness (Ra) of the magnetic layer can be suitably controlled by adjusting the dispersion of ferromagnetic powder in the magnetic layer, and/or adjusting the particle size and quantity of abrasives and/or carbon black added to the magnetic layer. The centerline average surface roughness (Ra) can be reduced by improving microdispersion of the ferromagnetic powder, reducing the particle size of the abrasive and carbon black, and/or reducing the quantities added. Further, a calendering step can also be used to reduce the centerline average surface roughness (Ra). The centerline average surface roughness (Ra) can also be reduced by increasing the linear pressure, increasing the pressure load time, and/or increasing the processing temperature.

The various layers of the magnetic recording medium of the present invention will be described in detail below.

Magnetic Layer

Hexagonal ferrite powder and ferromagnetic metal powder are examples of the ferromagnetic powder contained in the magnetic layer in the magnetic recording medium of the present invention.

Examples of hexagonal ferrite powders suitable for use in the present invention are barium ferrite, strontium ferrite, lead ferrite, calcium ferrite, and various substitution products thereof, and Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spine1 phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sn—Zn—Co, and Nb—Zn have been added may generally also be employed. They may comprise specific impurities depending on the starting materials and manufacturing methods employed.

The particle size, as a hexagonal plate diameter, preferably ranges from 10 to 100 nm, more preferably 10 to 60 nm, further preferably 10 to 50 nm. Particularly when employing an MR head in reproduction to increase a track density, a plate diameter equal to or less than 40 nm is desirable to reduce noise. A mean plate diameter equal to or higher than 10 nm yields stable magnetization without the effects of thermal fluctuation. A mean plate diameter equal to or less than 100 nm permits low noise and is suited to the high-density magnetic recording. The plate ratio (plate diameter/plate thickness) of the hexagonal ferrite powder preferably ranges from 1 to 15, more preferably from 1 to 7. Low plate ratio is preferable to achieve high filling property of the magnetic layer, but some times adequate orientation is not achieved. When the plate ratio is higher than 15, noise may be increased due to stacking between particles. The specific surface area by BET method of the hexagonal ferrite powders having such particle sizes ranges from 10 to 100 m²/g, almost corresponding to an arithmetic value from the particle plate diameter and the plate thickness. Narrow distributions of particle plate diameter and thickness are normally good. Although difficult to render in number form, about 500 particles can be randomly measured in a transmission electron microscope (TEM) photograph of particles to make a comparison. This distribution is often not a normal distribution. However, when expressed as the standard deviation to the average particle size, sigma/average particle size=0.1 to 2.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of about 500 to 5,000 Oe, approximately 40 to 398 kA/m, can normally be achieved. A high coercivity (Hc) is advantageous for high-density recording, but this is limited by the capacity of the recording head. The hexagonal ferrite powder employed in the present invention preferably has a coercivity (Hc) ranging from 2,000 to 4,000 Oe, approximately 160 to 320 kA/m, more preferably 2,200 to 3,500 Oe, approximately 176 to 280 kA/m. When the saturation magnetization of the head exceeds 1.4 tesla, the hexagonal ferrite having a coercivity (Hc) of equal to or higher than 2,200 Oe (176 kA/m) is preferably employed. The coercivity (Hc) can be controlled by particle size (plate diameter and plate thickness), the types and quantities of elements contained, substitution sites of the element, the particle producing reaction conditions, and the like. The saturation magnetization (sigmaₛ) can be 40 to 80 A·m²/kg. The higher saturation magnetization (sigmaₛ) is preferred, however, it tends to decrease with decreasing particle size. Known methods of improving saturation magnetization (sigmaₛ) are combining spinel ferrite with magnetoplumbite ferrite, selection of the type and quantity of elements incorporated, and the like. It is also possible to employ W-type hexagonal ferrite. When dispersing the hexagonal ferrite powder, the surface of the hexagonal ferrite powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added can range from 0.1 to 10 weight percent relative to the weight of the hexagonal ferrite powder. The pH of the hexagonal ferrite powder is also important to dispersion. A pH of about 4 to 12 is usually optimum for the dispersion medium and polymer. From the perspective of the chemical stability and storage properties of the medium, a pH of about 6 to 11 can be selected. Moisture contained in the hexagonal ferrite powder also affects dispersion. There is an optimum level for the dispersion medium and polymer, usually selected from the range of 0.01 to 2.0 weight percent. Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to 100° C. or greater; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. However, any manufacturing method can be selected in the present invention.

The ferromagnetic metal powder employed in the magnetic layer is not specifically limited, but preferably a ferromagnetic metal power comprised primarily of alpha-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to alpha-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014, which are expressly incorporated herein by reference in their entirety.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed in the magnetic layer is preferably 45 to 100 m²/g, more preferably 50 to 80 m²/g. At 45 m²/g and above, low noise is achieved. At 100 m²/g and below, good surface properties are achieved. The crystallite size of the ferromagnetic metal powder is preferably 80 to 180 Angstroms, more preferably 100 to 180 Angstroms, and still more preferably, 110 to 175 Angstroms. The major axis length of the ferromagnetic metal powder is preferably equal to or greater than 0.01 micrometer and equal to or less than 0.15 micrometer, more preferably equal to or greater than 0.02 micrometer and equal to or less than 0.15 micrometer, and still more preferably, equal to or greater than 0.03 micrometer and equal to or less than 0.12 micrometer. The acicular ratio of the ferromagnetic metal powder is preferably equal to or greater than 3 and equal to or less than 15, more preferably equal to or greater than 5 and equal to or less than 12. The sigmaₛ of the ferromagnetic metal powder is preferably 100 to 180 A·m²/kg, more preferably 110 to 170 A·m²/kg, and still more preferably, 125 to 160 A·m²/kg. The coercivity of the ferromagnetic powder is preferably 2,000 to 3,500 Oe, approximately 160 to 280 kA/m, more preferably 2,200 to 3,000 Oe, approximately 176 to 240 kA/m.

The moisture content of the ferromagnetic metal powder is desirably 0.01 to 2 percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at 200 ppm or less. The ferromagnetic metal powder employed in the present invention desirably has few voids; the level is preferably 20 volume percent or less, more preferably 5 volume percent or less. As stated above, so long as the particle size characteristics are satisfied, the ferromagnetic metal powder may be acicular, rice grain-shaped, or spindle-shaped. The SFD of the ferromagnetic metal powder itself is desirably low, with 0.8 or less being preferred. The Hc distribution of the ferromagnetic metal powder is desirably kept low. When the SFD is 0.8 or lower, good electromagnetic characteristics are achieved, output is high, and magnetic inversion is sharp, with little peak shifting, in a manner suited to high-density digital magnetic recording. To keep the Hc low, the methods of improving the particle size distribution of goethite in the ferromagnetic metal powder and preventing sintering may be employed.

Nonmagnetic Layer

A nonmagnetic layer is present between the nonmagnetic support and magnetic layer in the magnetic recording medium of the present invention. This nonmagnetic layer contains at least a nonmagnetic powder and binder. The nonmagnetic layer will be described in detail below.

The nonmagnetic layer, so long as it is essentially nonmagnetic, is not specifically limited, and may contain magnetic powder to the extent that it remains essentially nonmagnetic. The term “essentially nonmagnetic” means that the nonmagnetic layer may possess magnetism to the extent that the electromagnetic characteristics of the magnetic layer are essentially not diminished. For example, a residual magnetic flux density of equal to or less than 0.01 T or a coercivity of equal to or less than 7.96 kA/m, approximately 100 Oe, is acceptable, with no residual magnetic flux density or coercivity at all being preferred.

The nonmagnetic powder comprised in the nonmagnetic layer can be selected from inorganic compounds such as metal oxides, metal carbonates, metal sulfates, metal nitrides, metal carbides, metal sulfides and the like. Examples of inorganic compounds are alpha-alumina having an alpha-conversion rate of 90 to 100 percent, beta-alumina, gamma-alumina, silicon carbide, chromium oxide, cerium oxide, alpha-iron oxide, hematite, goethite, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate and molybdenum disulfide; these may be employed singly or in combination. Particularly desirable are titanium dioxide, zinc oxide, iron oxide and barium sulfate due to their narrow particle distribution and numerous means of imparting functions. Even more preferred is titanium dioxide and alpha-iron oxide. The mean particle diameter of these nonmagnetic powders preferably ranges from 0.005 to 2 micrometers, but nonmagnetic powders of differing particle size may be combined as needed, or the particle diameter distribution of a single nonmagnetic powder may be broadened to achieve the same effect. What is preferred most is a mean particle diameter in the nonmagnetic powder ranging from 0.01 to 0.2 micrometer. Particularly when the nonmagnetic powder is a granular metal oxide, a mean particle diameter equal to or less than 0.08 micrometer is preferred, and when an acicular metal oxide, the mean major axis length is preferably equal to or less than 0.3 nicrometer, more preferably equal to or less than 0.2 micrometer. The tap density preferably ranges from 0.05 to 2 g/ml, more preferably from 0.2 to 1.5 g/ml. The moisture content of the nonmagnetic powder preferably ranges from 0.1 to 5 weight percent, more preferably from 0.2 to 3 weight percent, further preferably from 0.3 to 1.5 weight percent. The pH of the nonmagnetic powder preferably ranges from 2 to 11, and the pH between 5.5 to 10 is particular preferred.

The specific surface area of the nonmagnetic powder preferably ranges from 1 to 100 m²/g, more preferably from 5 to 80 m²/g, further preferably from 10 to 70 m²/g. The crystallite size of the nonmagnetic powder preferably ranges from 0.004 micrometer to 1 micrometer, further preferably from 0.04 micrometer to 0.1 micrometer. The oil absorption capacity using dibutyl phthalate (DBP) preferably ranges from 5 to 100 ml/100 g, more preferably from 10 to 80 ml/10 g, further preferably from 20 to 60 ml/100 g. The specific gravity preferably ranges from 1 to 12, more preferably from 3 to 6. The shape of the nonmagnetic powder may be any of acicular, spherical, polyhedral, or plate-shaped. The nonmagnetic powder having a Mohs' hardness ranging from 4 to 10 is preferred. The stearic acid (SA) adsorption capacity of the nonmagnetic powder preferably ranges from 1 to 20 micromol/m², more preferably from 2 to 15 micromol/m², further preferably from 3 to 8 micromol/m². The pH of the nonmagnetic powder preferably ranges from 3 to 6. The surface of these nonmagnetic powders is preferably treated with Al₂O₃, SiO₂, TiO₂, ZrO₂, SnO₂, Sb₂O₃, ZnO and Y₂O₃. The surface-treating agents of preference with regard to dispersibility are Al₂O₃, SiO₂, TiO₂ and ZrO₂, and Al₂O₃, SiO₂ and ZrO₂ are further preferable. These may be used singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders are: Nanotite from Showa Denko K. K.; HIT-100 and ZA-G1 from Sumitomo Chemical Co., Ltd.; alpha-hematite DPN-250, DPN-250BX, DPN-245, DPN-270BX, DPN-500BX, DBN-SA1 and DBN-SA3 from Toda Kogyo Corp.; titanium oxide TTO-51B, TTO-55A, TTO-55B, TTO-55C, TTO-55S, TTO-55D, SN-100, alpha-hematite E270, E271, E300 and E303 from Ishihara Sangyo Co., Ltd.; titanium oxide STT-4D, STT-30D, STT-30, STT-65C, and alpha-hematite alpha-40 from Titan Kogyo K. K.; MT-100S, MT-100T, MT-150W, MT-500B, MT-600B, MT-100F, and MT-500HD from Tayca Corporation; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO₂P25 from Nippon Aerogil; 100A and 500A from Ube Industries, Ltd.; and sintered products of the same. Particular preferable nonmagnetic powders are titanium dioxide and alpha-iron oxide.

Based on the objective, an organic powder may be added to the nonmagnetic layer. Examples are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827, which are expressly incorporated herein by reference in their entirety, may be employed.

The thermoplastic resins, thermosetting resins, reactive resins, and mixtures of the same may that have been described as binder components suitable for use in the magnetic layer may be employed as the binder of the nonmagnetic layer. The content of binder in the nonmagnetic layer falls within a range of, for example, 5 to 50 weight percent, preferably a range of 10 to 30 weight percent, of the nonmagnetic powder. When employing vinyl chloride resin, the binder content is desirably 5 to 30 weight percent; when employing polyurethane resin, the binder content is desirably 2 to 20 weight percent; and when employing polyisocyanate, the binder content is desirably 2 to 20 weight percent. These are desirably combined for use. For example, when head corrosion occurs due to a low level of dechlorination, it is possible to employ polyurethane alone or just polyurethane and isocyanate. When employing polyurethane in the nonmagnetic layer, polyurethane with a glass transition temperature of −50 to 150° C., preferably 0 to 100° C., and more preferably, 30 to 90° C.; an elongation at break of 100 to 2,000 percent; a stress at break of 0.05 to 10 kg/mm², approximately 0.49 to 98 MPa, and a yield point of 0.05 to 10 kg/mm², approximately 0.49 to 98 MPa, is desirably employed.

The quantity of binder added to the nonmagnetic layer; the proportion of vinyl chloride resin, polyurethane resin, polyisocyanate, or some other resin in the binder; the molecular weight of the various resins; the quantity of polar groups; the above-described physical characteristics of the resin; and the like may be altered as necessary and known techniques may be applied. For example, to improve head touch, the quantity of binder in the nonmagnetic layer may be increased to impart flexibility.

The polyisocyanates described above as magnetic layer components are examples of polyisocyanates that can be employed in the nonmagnetic layer.

Carbon Black

The magnetic recording medium of the present invention can comprise carbon black in the magnetic layer and/or nonmagnetic layer. Examples of types of carbon black that are suitable for use are: furnace black for rubber, thermal for rubber, black for coloring and acetylene black. A specific surface area of 5 to 500 m²/g, a DBP oil absorption capacity of 10 to 400 ml/100 g, and an average particle size of 5 to 300 nm, preferably 10 to 250 nm, more preferably 20 to 200 nm are respectively desirable. A pH of 2 to 10, a moisture content of 0.1 to 10 percent, and a tap density of 0.1 to 1 g/cc are respectively desirable. Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Lion Akzo Co., Ltd. The carbon black employed may be surface-treated with a dispersant or grafted with resin, or have a partially graphite-treated surface. The carbon black may be dispersed in advance into the binder prior to addition to the coating liquid. These carbon blacks may be used singly or in combination. The quantity of carbon black preferably ranges from 0.1 to 30 weight percent relative to the ferromagnetic powder or nonmagnetic powder. In the magnetic layer, carbon black works to prevent static, reduce the coefficient of friction (impart smoothness), impart light-blocking properties, enhance film strength, and the like; the properties vary with the type of carbon black employed. When carbon black is mixed into the nonmagnetic layer to achieve the known effect of reducing surface resistivity, Rs, not only can the optical transmittance also be reduced, but a desired micro-Vicker's hardness can also be achieved. A lubricant stockpiling effect can also be achieved by incorporating carbon black into the nonmagnetic layer. Accordingly, the types, quantities, and combinations of carbon black in the magnetic layer and nonmagnetic layer can be varied and different types of carbon black employed in the present invention based on objectives determined by various characteristics such as particle size, oil absorption capacity, electrical conductivity, and pH. The carbon black should be optimized for each layer. For example, Carbon Black Handbook compiled by the Carbon Black Association, which is expressly incorporated herein by reference in its entirety, may be consulted for types of carbon black suitable for use in the magnetic layer and/or nonmagnetic layer.

Abrasives

Known materials chiefly having a Mohs' hardness of 6 or greater may be employed either singly or in combination as abrasives in the present invention. These include: alpha-alumina with an alpha-conversion rate of equal to or greater than 90 percent, beta-alumina, silicon carbide, chromium oxide, cerium oxide, alpha-iron oxide, corundum, synthetic diamond, silicon nitride, silicon carbide, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers, more preferably 0.05 to 1.0 micrometer, and further preferably, 0.05 to 0.5 micrometer. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed in the present invention may be acicular, spherical, cubic, or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle size and quantity of the abrasives added to the magnetic layer and nonmagnetic layer should be set to optimal values.

Additives

Substances having lubricating effects, antistatic effects, dispersive effects, plasticizing effects, or the like may be employed as additives in the magnetic layer and nonmagnetic layer. Examples of additives are: molybdenum disulfide; tungsten disulfide; graphite; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; phenylphosphonic acid; alpha-naphthylphosphoric acid; phenylphosphoric acid; diphenylphosphoric acid; p-ethylbenzenephosphonic acid; phenylphosphinic acid; aminoquinones; various silane coupling agents and titanium coupling agents; fluorine-containing alkylsulfuric acid esters and their alkali metal salts; monobasic fatty acids (which may contain an unsaturated bond or be branched) having 10 to 24 carbon atoms and metal salts (such as Li, Na, K, and Cu) thereof; monohydric, dihydric, trihydric, tetrahydric, pentahydric or hexahydric alcohols with 12 to 22 carbon atoms (which may contain an unsaturated bond or be branched); alkoxy alcohols with 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty acid esters of monoalkyl ethers of alkylene oxide polymers; fatty acid amides with 8 to 22 carbon atoms; and aliphatic amines with 8 to 22 carbon atoms.

Specific examples of the additives in the form of fatty acids are: capric acid, caprylic acid, lauric acid, myristic acid, palmitic acid, stearic acid, behenic acid, oleic acid, elaidic acid, linolic acid, linolenic acid, and isostearic acid. Examples of esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentylglycol didecanoate, and ethylene glycol dioleyl. Examples of alcohols are oleyl alcohol, stearyl alcohol, and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.), which is expressly incorporated herein by reference in its entirety. These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

The lubricants and surfactants suitable for use in the present invention each have different physical effects. The type, quantity, and combination ratio of lubricants producing synergistic effects should be optimally set for a given objective. It is conceivable to control bleeding onto the surface through the use of fatty acids having different melting points in the nonmagnetic layer and the magnetic layer; to control bleeding onto the surface through the use of esters having different boiling points, melting points, and polarity; to improve the stability of coatings by adjusting the quantity of surfactant; and to increase the lubricating effect by increasing the amount of lubricant in the intermediate layer. The present invention is not limited to these examples. Generally, a total quantity of lubricant ranging from 0.1 to 50 weight percent, preferably from 2 to 25 weight percent with respect to the ferromagnetic powder in the magnetic layer or the nonmagnetic powder in the nonmagnetic layer is preferred.

All or some of the additives used in the present invention may be added at any stage in the process of manufacturing the magnetic and nonmagnetic coating liquids. For example, they may be mixed with the ferromagnetic powder before a kneading step; added during a step of kneading the ferromagnetic powder, the binder, and the solvent; added during a dispersing step; added after dispersing; or added immediately before coating. Part or all of the additives may be applied by simultaneous or sequential coating after the magnetic layer has been applied to achieve a specific purpose. Depending on the objective, the lubricant may be coated on the surface of the magnetic layer after calendering or making slits. Known organic solvents may be employed in the present invention. For example, the solvents described in Japanese Unexamined Patent Publication (KOKAI) Showa No. 6-68453, which is expressly incorporated herein by reference in its entirety, may be employed.

Layer Structure

In the magnetic recording medium of the present invention, the thickness of the nonmagnetic support preferably ranges from 2 to 100 micrometers, more preferably from 2 to 80 micrometers. For computer-use magnetic recording tapes, the nonmagnetic support having a thickness of 3.0 to 6.5 micrometers, preferably 3.0 to 6.0 micrometers, more preferably 4.0 to 5.5 micrometers is suitably employed.

An undercoating layer may be provided to improve adhesion between the nonmagnetic support and the nonmagnetic layer or magnetic layer. The thickness of the undercoating layer can be made from 0.01 to 0.5 micrometer, preferably from 0.02 to 0.5 micrometer. The magnetic recording medium of the present invention may be a disk-shaped medium in which a nonmagnetic layer and magnetic layer are provided on both sides of the nonmagnetic support, or may be a tape-shaped or disk-shaped magnetic recording medium having these layers on just one side. In the latter case, a backcoat layer may be provided on the opposite surface of the nonmagnetic support from the surface on which is provided the magnetic layer to achieve effects such as preventing static and compensating for curl. The thickness of the backcoat layer is, for example, from 0.1 to 4 micrometers, preferably from 0.3 to 2.0 micrometers. Known undercoating layers and backcoat layers may be employed.

The nonmagnetic layer is normally 0.2 to 5.0 micrometers, preferably 0.3 to 3.0 micrometers, and more preferably, 0.4 to 2.0 micrometers in thickness. The nonmagnetic layer exhibits its effect so long as it is substantially nonmagnetic. For example, the effect of the present invention is exhibited even when trace quantities of magnetic material are incorporated as impurities or intentionally incorporated, and such incorporation can be viewed as substantially the same configuration as the present invention.

Backcoat Layer

Generally, computer data recording-use magnetic recording medium (magnetic tapes) are required to have far better repeat running properties than audio and video tapes. Carbon black and inorganic powders are desirably incorporated into the backcoat layer to maintain high running durability.

Examples of inorganic powders that can be added to the backcoat layer are inorganic powders having an average particle size of 80 to 250 nm and a Mohs' hardness of 5 to 9. Examples of inorganic powders that are suitable for use are: alpha-iron oxide, alpha-alumina, chromium oxide (Cr₂O₃), and TiO₂. Of these, alpha-iron oxide, alpha-alumina are employed with preference.

Any of the carbon blacks commonly employed in magnetic recording media may be widely employed in the backcoat layer. For example, furnace black for rubber, thermal for rubber, black for coloring and acetylene black may be employed. To ensure that irregularities in the backcoat do not transfer to the magnetic layer, the particle diameter of the carbon black is desirably 0.3 micrometer or smaller, with 0.01 to 0.1 micrometer being preferred. Carbon black is desirably employed in the backcoat layer in a quantity ensuring an optical transmittance (the transmittance level as measured by the TR-927 made by Macbeth Corp.) of 2.0 or less.

The use of two types of carbon black having different particle sizes is advantageous to enhance running durability. In this case, a first carbon black having a mean particle size falling within a range of 0.01 to 0.04 micrometer and a second carbon black having a mean particle size falling within a range of 0.05 to 0.3 micrometer are desirably combined. The content of the second carbon black is suitably 0.1 to 10 weight parts, preferably 0.3 to 3 weight parts, per 100 weight parts of the sum of inorganic powders and the first carbon black. The quantity of binder employed can be selected within a range of 10 to 40 weight parts, preferably 20 to 32 weight parts, per 100 weight parts of the total weight of inorganic powder and carbon black. Conventionally known thermoplastic resins, thermosetting resins, reactive resins, and the like may be employed as the binder used in the backcoat layer.

Nonmagnetic Support

Known films of the following may be employed as the nonmagnetic support in the present invention: polyethylene terephthalate, polyethylene naphthalate, other polyesters, polyolefins, cellulose triacetate, polycarbonate, polyamides, polyimides, polyamidoimides, polysulfones, aromatic polyamides, polybenzooxazoles, and the like. Supports having a glass transition temperature of equal to or higher than 100° C. are preferably employed. The use of polyethylene naphthalate, aramid, or some other high-strength support is particularly desirable. As needed, layered supports such as disclosed in Japanese Unexamined Patent Publication (KOKAI) Heisei No. 3-224127, which is expressly incorporated herein by reference in its entirety, may be employed to vary the surface roughness of the magnetic surface and support surface. These supports may be subjected beforehand to corona discharge treatment, plasma treatment, adhesion enhancing treatment, heat treatment, dust removal, and the like.

The center surface average surface roughness (SRa) of the support measured with an optical interferotype surface roughness meter HD-2000 made by WYKO is preferably equal to or less than 8.0 nm, more preferably equal to or less than 4.0 nm, further preferably equal to or less than 2.0 nm. Not only does such a support desirably have a low center surface average surface roughness, but there are also desirably no large protrusions equal to or higher than 0.5 micrometer. The surface roughness shape may be freely controlled through the size and quantity of filler added to the support as needed. Examples of such fillers are oxides and carbonates of elements such as Ca, Si, and Ti, and organic fine powders such as acrylic-based one. The support desirably has a maximum height Rₘₐₓ equal to or less than 1 micrometer, a ten-point average roughness R_{Z} equal to or less than 0.5 micrometer, a center surface peak height R_{P} equal to or less than 0.5 micrometer, a center surface valley depth R_{V} equal to or less than 0.5 micrometer, a center-surface surface area percentage Sr of 10 percent to 90 percent, and an average wavelength lambdaₐ of 5 to 300 micrometers. To achieve desired electromagnetic characteristics and durability, the surface protrusion distribution of the support can be freely controlled with fillers. It is possible to control within a range from 0 to 2,000 protrusions of 0.01 to 1 micrometer in size per 0.1 mm².

The F-5 value of the nonmagnetic support employed in the present invention desirably ranges from 5 to 50 kg/mm², approximately 49 to 490 MPa. The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength of the nonmagnetic support preferably ranges from 5 to 100 kg/mm², approximately 49 to 980 MPa. The modulus of elasticity preferably ranges from 100 to 2,000 kg/mm², approximately 0.98 to 19.6 GPa. The thermal expansion coefficient preferably ranges from 10⁻⁴ to 10⁻⁸/° C., more preferably from 10⁻⁵ to 10⁻⁶/° C. The moisture expansion coefficient is preferably equal to or less than 10⁻⁴/RH percent, more preferably equal to or less than 10⁻⁵/RH percent. These thermal characteristics, dimensional characteristics, and mechanical strength characteristics are desirably nearly equal, with a difference equal to less than 10 percent, in all in-plane directions in the support.

Manufacture of Coating Liquid

The process for manufacturing coating liquids for magnetic and nonmagnetic layers comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. When a kneader is employed, the ferromagnetic powder or nonmagnetic powder and all or part of the binder (preferably equal to or higher than 30 weight percent of the entire quantity of binder) are kneaded in a range of 15 to 500 parts per 100 parts of the ferromagnetic powder. Details of the kneading process are described in Japanese Unexamined Patent Publication (KOKAI) Heisei Nos. 1-106338 and 1-79274. Further, glass beads may be employed to disperse the coating liquids for magnetic and nonmagnetic layers, with a dispersing medium with a high specific gravity such as zirconia beads, titania beads, and steel beads being suitable for use. The particle diameter and fill ratio of these dispersing media are optimized for use. A known dispersing device may be employed.

Manufacture Method of Magnetic Recording Medium

The feature of the present invention further relates to a method of manufacturing a magnetic recording medium comprising coating a nonmagnetic layer coating liquid on a nonmagnetic support and drying the nonmagnetic layer coating liquid to form a nonmagnetic layer, followed by coating a magnetic layer coating liquid on the nonmagnetic layer and drying the magnetic layer coating liquid to form a magnetic layer. The magnetic layer coating liquid comprises a ferromagnetic powder and a binder and the binder comprises a resin having a weight average molecular weight, Mw, of equal to or greater than 120,000. The magnetic recording medium of the present invention mentioned above can be manufactured by this manufacturing method.

The magnetic layer coating liquid comprises a resin having a weight average molecular weight (Mw) of equal to or greater than 120,000. As set forth above, incorporating this resin permits an increase in the adsorption amount of the binder to ferromagnetic power in the magnetic layer coating liquid, thereby decreasing or preventing orientation aggregation. A detailed description of the resin having a weight average molecular weight (Mw) of equal to or greater than 120,000 has been given above.

The content of the resin having a weight average molecular weight (Mw) of equal to or greater than 120,000 in the magnetic layer coating liquid is as set forth above. The magnetic layer coating liquid may contain a compound having a thermosetting functional group in addition to the resin. Such a compound has been described in detail above.

When a magnetic layer coating liquid containing such a compound is employed, heating following coating induces a crosslinking reaction between the resin and the compound, yielding a magnetic layer containing the reaction product of the resin and the compound containing the thermosetting functional group. Since this magnetic layer has a coating strength that is greater than a magnetic layer containing resin alone, a magnetic recording medium of greater durability is obtained. When the magnetic layer coating liquid contains a compound having a thermosetting functional group, the content thereof is preferably 5 to 40 weight percent, more preferably 10 to 30 weight percent, and further preferably, 15 to 25 weight percent, of all the binder contained in the magnetic layer.

Further, to ensure good electromagnetic characteristics, the total quantity of binder is preferably 10 to 50 weight percent, more preferably 15 to 40 weight percent, and further preferably, 20 to 30 weight percent, of the ferromagnetic powder in the magnetic layer coating liquid.

As set forth above, the magnetic layer coating liquid can contain other binder components (components containing thermosetting functional groups; resin components; and the like) in addition to the above resin. The details thereof have been set forth above. To achieve both the effect of preventing orientation aggregation and good electromagnetic characteristics by adding a resin with a weight average molecular weight (Mw) of equal to or greater than 120,000, the quantity of the other binder components is preferably 10 to 80 weight percent, more preferably 20 to 60 weight percent, and further preferably, 20 to 40 weight percent, of the resin having a weight average molecular weight (Mw) of equal to or greater than 120,000. Further, to achieve an effect by adding the binder component, the content of the binder component in addition to the resin with a weight average molecular weight (Mw) of equal to or greater than 120,000 in the magnetic layer coating liquid is preferably equal to or greater than 2.5 weight percent, more preferably 4 to 40 weight percent, further preferably 5 to 30 weight percent, and still more preferably, 5 to 25 weight percent, of the ferromagnetic powder.

In the method of manufacturing a magnetic recording medium of the present invention, the addition of a resin having a weight average molecular weight (Mw) of equal to or greater than 120,000 to the magnetic layer coating liquid effectively prevents orientation aggregation occurring when employing a magnetic layer coating liquid of low concentration to form a thin magnetic layer. The concentration of the solid component (ferromagnetic powder, binder, and the like) of the magnetic layer coating liquid can be suitably adjusted based on the thickness of the magnetic layer, and may be, for example, 10 to 25 weight percent, preferably 10 to 23 weight percent, and more preferably, 12 to 20 weight percent. When employing a magnetic layer coating liquid of relatively low concentration in this manner, the present invention can be effectively applied. Further, the magnetic layer formed using a magnetic layer coating liquid of low concentration in this manner is desirably 10 to 300 nm, preferably 20 to 200 nm, and more preferably, 30 to 100 nm in thickness, for example.

As set forth above, the resin having a weight average molecular weight of equal to or greater than 120,000 is highly adsorptive to ferromagnetic powder particles. Thus, the use of a binder containing this resin makes it possible for the binder to adsorb to a large quantity of ferromagnetic powder particles in the magnetic layer coating liquid. The quantity of the binder adsorbing to the ferromagnetic powder in the magnetic layer coating liquid is preferably equal to or greater than 80 mg, more preferably equal to or greater than 100 mg, and further preferably, equal to or greater than 120 mg, per 1,000 mg of ferromagnetic powder. The greater the quantity adsorbed, the better. However, in practice, the upper limit is about 300 mg, for example. The quantity adsorbed can be determined by centrifugally separating the magnetic layer coating liquid in a centrifuge to cause the ferromagnetic powder particles to precipitate out, and measuring the concentration of binder in the supernatant.

Coating Method

The nonmagnetic layer and magnetic layer may be formed by a known process, such as an extrusion coating method, roll coating method, gravure coating method, microgravure coating method, air knife coating method, die coating method, curtain coating method, dip coating method, or wire bar coating method. The magnetic layer is desirably formed by an extrusion coating method.

To form the magnetic layer, a coating method is desirably employed in which there are two slits, one for coating and one for recovery, an excess amount of coating liquid is discharged from the coating slit, and the excess amount of coating liquid following coating on a web is picked up by aspiration into the recovery slit. In this coating method, the pressure conditions for aspirating the excess coating liquid through the recovery slit are desirably optimized to produce a magnetic layer in the form of a thin film that is free of coating nonuniformity.

Specifically, it is preferable that the formation of the nonmagnetic layer and magnetic layer is carried out on a continuously running nonmagnetic support, and the coating of the magnetic layer coating liquid is carried out by discharging the magnetic layer coating liquid that has been fed into a coating head from a coating slit of the coating head onto the nonmagnetic layer in a quantity in excess of the quantity required to form a magnetic layer of desired thickness while the nonmagnetic layer formed on the nonmagnetic support and a lip surface of the font end of the coating head are in a state of close proximity, and the magnetic layer coating liquid that has been coated in excess is picked up by aspiration through a recovery slit provided downstream from the coating slit as viewed in the running direction of the nonmagnetic support, wherein the aspiration is carried out so as to satisfy equation (I) below when the liquid pressure at the aspiration inlet of the recovery slit is denoted as P (MPa):
0.05>P≧0 (I)

In the above coating method, when a pump aspirating the magnetic layer coating liquid that has been coated in excess is used for aspiration, the aspiration desirably satisfies equation (II) below when the pressure on the aspiration inlet side of the aspiration pump is denoted as PIN (MPa):
PIN≧−0.02 (II)

This coating method is described in detail in Japanese Unexamined Patent Publication (KOKAI) No. 2003-236452 or English language family member, US2003/0157251A1 and U.S. Pat. No. 6,759,091, which are expressly incorporated herein by reference in their entirety.

In the method of manufacturing the magnetic recording medium of the present invention, it is preferable that the formation of the nonmagnetic layer and the magnetic layer is carried out sequentially on the nonmagnetic support that is fed from a nonmagnetic support stock roll, and following the formation of the nonmagnetic layer and magnetic layer, winding the nonmagnetic support to obtain a magnetic recording medium stock roll, and cutting part of the magnetic recording medium stock roll to obtain a magnetic recording medium in the form of a tape or disk. It is difficult to economically manufacture magnetic recording medium in large quantity by a method in which a nonmagnetic support that has been rolled up into a roll is fed to form the nonmagnetic layer, temporarily rolled up, and then fed again to form the magnetic layer. By contrast, as set forth above, the magnetic recording medium can be economically produced in large quantity by feeding rolled-up nonmagnetic support to form the nonmagnetic layer and then form the magnetic layer without rolling the nonmagnetic support back up. Further, during from the period from when the nonmagnetic support is fed to when it is rolled up, layers in addition to the nonmagnetic layer and magnetic layer are also desirably formed. For example, when an undercoating layer and backcoat layer are provided, these layers are desirably formed between when the nonmagnetic support is fed to when it is rolled up.

To enhance productivity, the rate at which the magnetic layer coating liquid is coated is preferably equal to or higher than 100 m/min, more preferably equal to or higher than 200 m/min, further preferably equal to or higher than 300 m/min, and still more preferably, equal to or higher than 400 m/min. The faster the coating rate, the better the productivity achieved. However, an excessively high coating rate tends to cause coating problems (coating striae, coating nonuniformity). Thus, a coating rate of equal to or lower than 700 m/min is desirable.

To orient the ferromagnetic powder in the magnetic layer in a desired orientation state, orientation processing is normally conducted following coating of the magnetic layer coating liquid while the magnetic layer coating liquid is still wet. As set forth above, in the present invention, a resin having a weight average molecular weight (Mw) of equal to or greater than 120,000 can be added to the magnetic layer coating liquid to reduce or prevent aggregation (orientation aggregation) of ferromagnetic powder particles during the orientation process. In the case of a disk, adequately isotropic orientation can sometimes be achieved with no orientation without using an orienting device. However, the diagonal arrangement of cobalt magnets in alternating fashion or the use of a known random orienting device such as a solenoid to apply an a.c. magnetic field is desirable. In the case of a ferromagnetic metal powder, the term “isotropic orientation” generally means randomness in the two in-plane dimensions, but can also be three-dimensional randomness when the vertical component is included. In the case of hexagonal ferrite, three-dimensional randomness in the in-plane directions and the vertical direction is generally readily achieved, but in-plane two-dimensional randomness is also possible. A known method such as magnets with opposite poles positioned opposite each other can also be employed to impart isotropic magnetic characteristics in a circumferential direction by effecting vertical orientation. When conducting particularly high-density recording, vertical orientation is desirable. Spin coating can also be employed to effect circumferential orientation. For magnetic tape, longitudinal orientation using cobalt magnets or solenoids is also possible.

The coating liquids use to form the various layers can be dried by blowing warm air onto the coating liquid after it has been applied, for example. The temperature of the air used for drying is desirably 60° C. or higher. The flow rate of the air used for drying can be set based on the amount of the coating and the temperature of the warm air. It is also possible to conduct suitable predrying prior to introduction into the magnetic zone for orientation processing following application of the magnetic layer coating liquid.

After coating and drying, the magnetic recording medium is normally calendered. The rolls used in calendering may be heat-resistant plastic rolls, such as rolls made of epoxy, polyimide, polyamide, or polyimidoamide, or metal rolls. When forming magnetic layers on both sides, the exclusive use of metal rolls is desirable. The processing temperature is desirably 50° C. or above, preferably 100° C. or above. The linear pressure is desirably 200 kg/cm, approximately 196 kN/m, or greater, preferably 300 kg/cm, approximately 294 kN/m, or greater.

### EXAMPLES

The present invention will be described in detail below based on examples. However, the present invention is not limited to the examples. Further, the “parts” given in Examples are weight parts unless specifically stated otherwise.

### Preparation of Magnetic Layer Coating Liquid A

The ferromagnetic metal particle, phosphoric acid dispersing agent (phenylphosphonic acid), polyurethane resin PUI, methyl ethyl ketone, and cyclohexanone stated below were dispersed by kneading in a known open kneader. To the kneaded product obtained were added the alpha-alumina and carbon black stated below, the mass was dispersed with a known dynomill (zirconia beads 0.5 mm in diameter), and a dispersion of ferromagnetic metal particle was prepared.

| | | |
|---|---|---|
| Ferromagnetic metal particle (acicular shape) | 100 | parts |
| Composition: Fe/Co = 100/25 | | |
| Coercivity (Hc): 215 kA/m (2700Oe) | | |
| Specific surface area (by BET method): 70 m²/g | | |
| Surface treatment agent: Al₂O₃, SiO₂, Y₂O₃ | | |
| Average major axis length: 45 nm | | |
| Average acicular ratio: 4 | | |
| Saturation magnetization Sigmaₛ: | | |
| 110 A · m²/kg (110 emu/g) | | |
| Phosphoric acid dispersing agent | 5 | parts |
| Polyurethane resin PU1 | 25 | parts |
| Weight average molecular weight (Mw) = 120,000 | | |
| Content of polar group, —SO₃Na: 70 eq./ton | | |
| Alpha-alumina | 5 | parts |
| Mohs' hardness: 9, average particle diameter: | | |
| 0.1 micrometer | | |
| Carbon black | 0.3 | part |
| Average particle diameter: 0.08 micrometer | | |
| Methyl ethyl ketone | 150 | parts |
| Cyclohexanone | 150 | parts |

Butyl stearate, stearic acid, methyl ethyl ketone, and cyclohexanone stated below were added to the dispersion that had been prepared, and the mixture was stirred and dispersion processed with a known ultrasonic dispersion device. The mixture was passed through a filter with an average pore size of 1 micrometer to prepare magnetic layer coating liquid A. The solid component concentration of magnetic layer coating liquid A was 14.6 weight percent.

| | |
|---|---|
| Butyl stearate | 1.5 parts |
| Stearic acid | 0.5 parts |
| Methyl ethyl ketone | 330 parts |
| Cyclohexanone | 170 parts |

Preparation of Magnetic Layer Coating Liquid B

With the exception that the 25 parts of polyurethane resin PU1 in magnetic layer coating liquid A were replaced with 15 parts of a polyurethane resin PU2 (weight average molecular weight (Mw): 170,000) having a molecular structure identical to that of polyurethane resin PU1 and 9 parts of polyvinylchloride resin (MR110, made by Nippon Zeon Co., Ltd.), magnetic layer coating liquid B was prepared in the same manner as magnetic layer coating liquid A.

Preparation of Magnetic Layer Coating Liquid C

With the exception that the 25 parts of polyurethane resin PU1 in magnetic layer coating liquid A were replaced with 8 parts of polyurethane resin PU2 (weight average molecular weight (Mw): 170,000) having a molecular structure identical to that of polyurethane resin PU1, 10 parts of polyvinylchloride resin (MR110, made by Nippon Zeon Co., Ltd.), and 8 parts of polyurethane resin PU5 (weight average molecular weight: 80,000) having the same molecular structure as polyurethane resin PU1, magnetic layer coating liquid C was prepared in the same manner as magnetic layer coating liquid A.

Preparation of Magnetic Layer Coating Liquid D

With the exception that the 25 parts of polyurethane resin PUI in magnetic layer coating liquid A were replaced with 12 parts of polyurethane resin PU3 (weight average molecular weight (Mw): 240,000) having the same molecular structure as polyurethane resin PU1, 10 parts of polyvinylchloride resin (MR110, made by Nippon Zeon Co., Ltd.), and 3 parts of polyurethane resin PU5 (weight average molecular weight (Mw): 80,000) having the same molecular structure as polyurethane resin PUI, magnetic layer coating liquid D was prepared in the same manner as magnetic layer coating liquid A.

Preparation of Magnetic Layer Coating Liquid E

With the exception that the 25 parts of polyurethane resin PU1 in magnetic layer coating liquid A were replaced with 6 parts of polyurethane resin PU2 (weight average molecular weight (Mw): 170,000) having a molecular structure identical to that of polyurethane resin PUI, 9 parts of polyvinylchloride resin (MR110, made by Nippon Zeon Co., Ltd.), 6 parts of polyurethane resin PU5 (weight average molecular weight (Mw): 80,000) having the same molecular structure as polyurethane resin PU1, a dispersion of ferromagnetic metal particles was prepared in the same manner as the dispersion of ferromagnetic metal particles in the preparation of magnetic layer coating liquid A. With the exception that 4 parts of polyisocyanate (Coronate L, made by Nippon Polyurethane Industry Co. Ltd.) were added to this dispersion, magnetic layer coating liquid E was prepared in the same manner as magnetic layer coating liquid A.

Preparation of Magnetic Layer Coating Liquid F

With the exception that the 25 parts of polyurethane resin PUI in magnetic layer coating liquid A were replaced with 7 parts of polyester resin (weight average molecular weight (Mw): 140,000, polar group: —SO₃Na, content of 75 eq./ton), 7 parts of polyvinylchloride resin (MR110, made by Nippon Zeon Co., Ltd.), and 8 parts of polyurethane resin PU5 (weight average molecular weight (Mw): 80,000) having the same molecular structure as polyurethane resin PU1, a dispersion of ferromagnetic metal particles was prepared in the same manner as the dispersion of ferromagnetic metal particles in the preparation of magnetic layer coating liquid A. With the exception that 4 parts of polyisocyanate (Coronate L, made by Nippon Polyurethane Industry Co. Ltd.) were added to this dispersion, magnetic layer coating liquid F was prepared in the same manner as magnetic layer coating liquid A.

Preparation of Magnetic Layer Coating Liquid G

With the exception that the 25 parts of polyurethane resin PU1 in magnetic layer coating liquid A were replaced with 20 parts of cellulose diacetate (weight average molecular weight (Mw): 200,000), a dispersion of ferromagnetic metal particles was prepared in the same manner as the dispersion of ferromagnetic metal particles in the preparation of magnetic layer coating liquid A. With the exception that 4 parts of polyisocyanate (Coronate L, made by Nippon Polyurethane Industry Co. Ltd.) were added to this dispersion, magnetic layer coating liquid G was prepared in the same manner as magnetic layer coating liquid A.

Preparation of Magnetic Layer Coating Liquid H

With the exception that the 25 parts of polyurethane resin PUI in magnetic layer coating liquid A were replaced with 2.5 parts of polyurethane resin PU4 (weight average molecular weight (Mw): 300,000) having a molecular structure identical to that of polyurethane resin PUI, 7 parts of polyvinylchloride resin (MR110, made by Nippon Zeon Co., Ltd.), and 12 parts of polyurethane resin PU5 (weight average molecular weight (Mw): 80,000) having the same molecular structure as polyurethane resin PU1, a dispersion of ferromagnetic metal particles was prepared in the same manner as the dispersion of ferromagnetic metal particles in the preparation of magnetic layer coating liquid A. With the exception that 2.5 parts of polyisocyanate (Coronate L, made by Nippon Polyurethane Industry Co. Ltd.) were added to this dispersion, magnetic layer coating liquid H was prepared in the same manner as magnetic layer coating liquid A.

Preparation of Magnetic Layer Coating Liquid I

With the exception that the 25 parts of polyurethane resin PU1 in magnetic layer coating liquid A were replaced with 6 parts of polyurethane resin PU1, 6 parts of polyurethane resin PU2 (weight average molecular weight (Mw): 170,000) having a molecular structure identical to that of polyurethane resin PU1, and 9 parts of polyvinylchloride resin (NMR10, made by Nippon Zeon Co., Ltd.), a dispersion of ferromagnetic metal particles was prepared in the same manner as the dispersion of ferromagnetic metal particles in the preparation of magnetic layer coating liquid A. With the exception that 4 parts of polyisocyanate (Coronate L, made by Nippon Polyurethane Industry Co. Ltd.) were added to this dispersion, magnetic layer coating liquid I was prepared in the same manner as magnetic layer coating liquid A.

Preparation of Magnetic Layer Coating Liquid J

With the exception that the 25 parts of polyurethane resin PU1 in magnetic layer coating liquid A were replaced with 25 parts of polyurethane resin PU5 (weight average molecular weight (Mw): 80,000) having the same molecular structure as polyurethane resin PU1, magnetic layer coating liquid J was prepared in the same manner as magnetic layer coating liquid A.

Preparation of Magnetic Layer Coating Liquid K

With the exception that the 25 parts of polyurethane resin PU1 in magnetic layer coating liquid A were replaced with 15 parts of polyurethane resin PU5 (weight average molecular weight (Mw): 80,000) having the same molecular structure as polyurethane resin PU1 and 9 parts of polyvinylchloride resin (MR110, made by Nippon Zeon Co., Ltd.), magnetic layer coating liquid K was prepared in the same manner as magnetic layer coating liquid A.

Preparation of Nonmagnetic Layer Coating Liquid

The nonmagnetic metal particles, carbon black, phosphoric acid dispersing agent (phenylphosphonic acid), polyvinylchloride resin, polyurethane resin, methyl ethyl ketone, and cyclohexanone stated below were dispersed by kneading in a known open kneader.

The kneaded product prepared was dispersed in a known dynomill (zirconia beads 0.5 mm in diameter) and a dispersion of nonmagnetic particles was prepared.

| | | |
|---|---|---|
| Nonmagnetic powder, alpha-Fe₂O₃ (acicular shape) | 80 | parts |
| Specific surface area (by BET method): 52 m²/g | | |
| Surface treatment agent: Al₂O₃, SiO₂ | | |
| Average major axis length: 100 nm | | |
| pH: 9.0 | | |
| Tap density: 0.8 g/cc | | |
| DBP oil absorption capacity: 27 to 38 g/100 g | | |
| Carbon black | 20 | parts |
| Average primary particle diameter: 16 micrometers | | |
| DBP oil absorption capacity: 120 mL/100 g | | |
| pH: 8.0 | | |
| Specific surface area (by BET method): 250 m²/g | | |
| Volatile content: 1.5 percent | | |
| Phosphoric acid dispersing agent | 3 | parts |
| Polyvinylchloride resin (MR110, made by | 12 | parts |
| Nippon Zeon Co., Ltd.) | | |
| Polyurethane resin | 7.5 | parts |
| (Branched side chain containing polyester | | |
| polyol/diphenylmetane diisocyanate based | | |
| one, polar group: —SO₃Na, content of 70 eq./ton) | | |
| Methyl ethyl ketone | 150 | parts |
| Cyclohexanone | 150 | parts |

Isocyanate, butyl stearate, stearic acid, methyl ethyl ketone, and cyclohexanone stated below were added to the above dispersion that had been prepared; stirred; and dispersed with a known ultrasonic dispersing device. The mixture was passed through a filter with an average pore diameter of 1 micrometer to prepare a nonmagnetic layer coating liquid.

| | | |
|---|---|---|
| Polyisocyanate | 5 | parts |
| (Coronate L, made by Nippon Polyurethane Industry Co. Ltd.) | | |
| Butyl stearate | 1.5 | parts |
| Stearic acid | 1 | part |
| Methyl ethyl ketone | 5 | parts |
| Cyclohexanone | 75 | parts |

Preparation of Backcoat Layer Coating Liquid

The starting materials and solvents stated below were kneaded by a known method and then dispersed in a known dynomill (zirconia beads 0.5 mm in diameter).

| | | |
|---|---|---|
| Carbon black A (average particle diameter: | 100 | parts |
| 0.04 micrometer) | | |
| Carbon black B (average particle diameter: 0.1 micrometer) | 5 | parts |
| Nonmagnetic particle, alpha-Fe₂O₃ | 20 | parts |
| (Average particle diameter: 0.11 micrometer, | | |
| Mohs' hardness: 5, pH: 9.0) | | |
| Alpha-alumina (average particle diameter: 0.2 micrometer) | 1 | parts |
| Nitrocellulose | 60 | parts |
| (Cellunova BTH ½ manufactured | | |
| by Asahi Kasei Corporation) | | |
| Polyurethane resin | 45 | parts |
| Copper phthalocyanine-based dispersant | 5 | parts |
| Copper oleate | 5 | parts |
| Precipitated barium sulfate | 5 | parts |
| Methyl ethyl ketone | 300 | parts |
| Toluene | 300 | parts |

The starting materials stated below were added to the dispersion that had been prepared and stirred. The mixture was passed through a filter with an average pore diameter of 1 micrometer to prepare a backcoat layer coating liquid.

| | |
|---|---|
| Polyester resin (Vylon 300 made by Toyobo Co., Ltd.) | 5 parts |
| Polyisocyanate (Coronate L, made by Nippon | 15 parts |
| Polyurethane Industry Co. Ltd.) | |

Preparation of Magnetic Recording Medium-1

### Example 1-1

The nonmagnetic layer coating liquid prepared as set forth above was coated by a known method to yield a film with a thickness of 1.0 micrometer upon drying on a polyethylene naphthalate (PEN) support (5 micrometers in thickness) that had been treated by a known method to enhance adhesion, and dried to prepare a nonmagnetic layer.

Magnetic layer coating liquid A prepared as set forth above was coated by the method described in Japanese Unexamined Patent Publication (KOKAI) No. 2003-236452 to yield a film with a thickness of 0.07 micrometer upon drying on the nonmagnetic layer that had been prepared. The magnetic layer was orientation processed with cobalt magnets having a magnetic force of 0.5 T (5,000 G) and a solenoid having a magnetic force of 0.4 T (4,000 G) following (0.5 second) coating of the magnetic layer coating liquid while the latter was still wet; and dried to prepare a magnetic layer. The coating rate was 300 m/min.

The backcoat layer coating liquid prepared as set forth above was coated by a known method to achieve a thickness upon drying of 0.5 micrometer on the opposite side of the PEN support from the magnetic layer and dried to prepare a backcoat layer.

During the period from when the PEN support was fed to when it was rolled up, three layers in the form of the nonmagnetic layer, magnetic layer, and backcoat layer were formed.

A seven-stage calendering device (linear pressure 300 kg/cm) comprised of metal rolls (temperature 100° C.) was used for surface smoothing at a processing rate of 150 m/min. A heat treatment of 70° C. was then applied for 40 hours and the product was slit into a magnetic recording medium ½ inch in width.

### Example 1-2

With the exception that magnetic layer coating liquid A was replaced with magnetic layer coating liquid B, a magnetic recording medium was prepared in the same manner as in Example 1-1.

### Example 1-3

With the exception that magnetic layer coating liquid A was replaced with magnetic layer coating liquid C, a magnetic recording medium was prepared in the same manner as in Example 1-1.

### Example 1-4

With the exception that magnetic layer coating liquid A was replaced with magnetic layer coating liquid D, a magnetic recording medium was prepared in the same manner as in Example 1-1.

### Example 1-5

With the exception that magnetic layer coating liquid A was replaced with magnetic layer coating liquid E, a magnetic recording medium was prepared in the same manner as in Example 1-1.

### Example 1-6

With the exception that magnetic layer coating liquid A was replaced with magnetic layer coating liquid F, a magnetic recording medium was prepared in the same manner as in Example 1-1.

### Example 1-7

With the exception that magnetic layer coating liquid A was replaced with magnetic layer coating liquid G a magnetic recording medium was prepared in the same manner as in Example 1-1.

### Example 1-8

With the exception that magnetic layer coating liquid A was replaced with magnetic layer coating liquid H, a magnetic recording medium was prepared in the same manner as in Example 1-1.

### Example 1-9

With the exception that magnetic layer coating liquid A was replaced with magnetic layer coating liquid I, a magnetic recording medium was prepared in the same manner as in Example 1-1.

### Comparative Example 1

With the exception that magnetic layer coating liquid A was replaced with magnetic layer coating liquid J, a magnetic recording medium was prepared in the same manner as in Example 1-1.

### Comparative Example 2

With the exception that magnetic layer coating liquid A was replaced with magnetic layer coating liquid K, a magnetic recording medium was prepared in the same manner as in Example 1-1.

Measurement of Weight Average Molecular Weight

The aforementioned weight average molecular weights of resins comprised in the magnetic layer coating liquids were measured by gel permeation chromatography (GPC, HLC8220GPC made by Tosoh Corporation).

Evaluation of the Magnetic Recording Media

The magnetic recording media prepared in Examples 1-1 to 1-9 and Comparative Examples 1-1 and 1-2 were evaluated with regard to the following items.

(1) Evaluation of Aggregation of Ferromagnetic Metal Particles as the Result of Magnetic Orientation

The surface of the magnetic layer of the magnetic recording medium was observed by scanning electron microscopy (SEM, 10.000-fold magnification) to determine whether or not aggregation (orientation aggregation) of the ferromagnetic metal particles was present in the coating direction of the magnetic recording medium. The degree of orientation aggregation was evaluated according to the following 3-step scale.

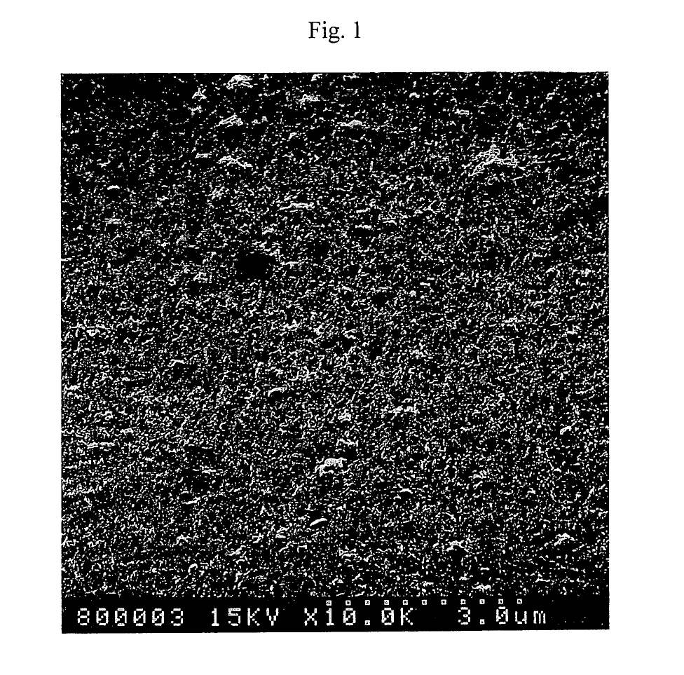

1: No orientation aggregation whatsoever (for example, Example 1-2 (FIG. 1))

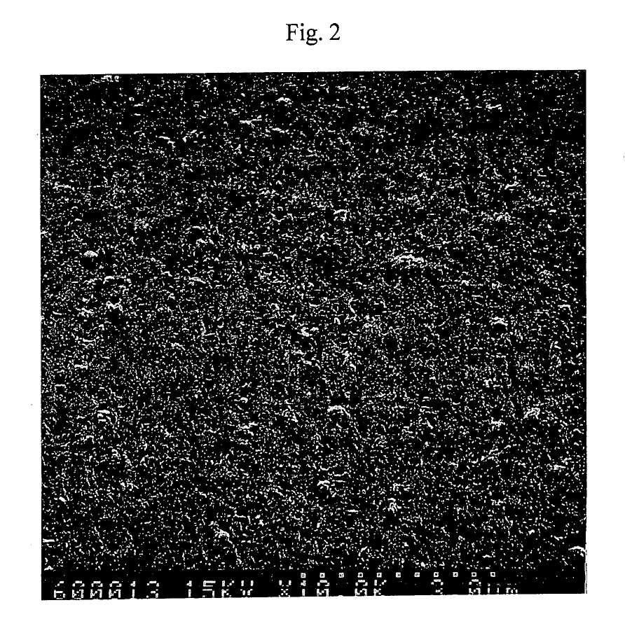

2: Little orientation aggregation (for example, Example 1-1 (FIG. 2))

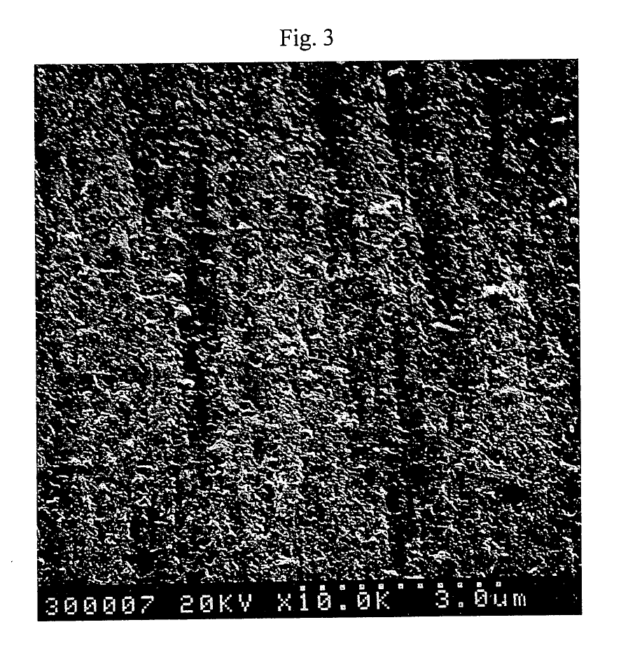

3: Marked orientation aggregation over the entire surface (for example, Comparative Example 1-1 (FIG. 3))

(2) Evaluation of Binder Adsorption Amount

A centrifuge was used to cause the ferromagnetic metal particles in the magnetic layer coating liquids that had been prepared to precipitate out. The solid component concentration in the supernatant was measured and the adsorption amount of the binder was calculated per 1000 mg of ferromagnetic metal particles. A small separation ultracentrifuge (CS150GXL, made by Hitachi High Technologies Corporation) was employed as the centrifuge. Centrifugation was conducted for 100 min. at 100,000 revolutions.

(3) Evaluation of Magnetic Characteristics

The magnetic characteristics were measured at an applied magnetic field of 79.6 kA/m (10 kOe) using a vibrating sample magnetometer (VSM-P7, made by Toei Industrial Co., Ltd.) and a data processing device made by the same company. The phim (coercivity per unit area) and SQ (squareness) were calculated.

(4) Evaluation of Surface Roughness

The centerline average surface roughness (Ra) of the magnetic layer surface was evaluated for each of the magnetic recording media by atomic force microscopy (AFM) (Nanoscope 3, made by Digital Instruments Corp.). Ra was measured for a 40 micrometer square (1,600 (micrometer)²) with the SiN probe of a square cone at an edge angle of 70°.

(5) Evaluation of Electromagnetic Characteristics

The electromagnetic characteristics of the magnetic recording media prepared were evaluated by the method described in Standard ECMA-319, Annex B. The BBSNR was employed as the S/N ratio. The difference in the S/N ratio was determined using LTO-Gen1 tape made by Fuji Photo Film Co., Ltd. The higher the numeric value, the better the electromagnetic characteristic.

(6) Evaluation of Error Rate

The error rate of the magnetic recording media prepared was measured by recording a signal with a linear recording density of 144 kbpi with the above LTO-Gen1 drive using an 8-10 conversion PRI equalization system and then reading the recorded signal with the LTO-Gen1 (made by IBM). The lower the numerical value, the lower the error rate.

(7) Evaluation of Dirtying of Magnetic Head Playback and rewind operations were repeated 100 times for the magnetic recording media in a 23° C., 50% R^{H} atmosphere with a drive equipped with a known MR head, and the amount of dirt adhering to the magnetic head following running was observed with a microscope and evaluated on a five-step scale. The less dirt that adhered to the magnetic head, the better.

1: No dirt

2: Almost no dirt

3: Trace amounts of dirt present

4: Some dirt present

5: Large amount of dirt present

Evaluation Results

The evaluation test results for each sample are given in Table 1.

TABLE 1

| | | Binder adsorption | | | | Electromagnetic | | |
|---|---|---|---|---|---|---|---|---|
| | Orientation | amount | Ra | Magnetic characteristics | | characteristics | | Dirtying of |
| | aggregation | (mg/1000 mg) | (nm) | φ m (G · μm) | SQ | (dB) | Error rate | magnetic head |
| Example 1-1 | 2 | 94 | 3.4 | 245 | 0.89 | +2.2 | 3 × 10E−6 | 3 |
| Example 1-2 | 1 | 127 | 3.0 | 250 | 0.89 | +2.5 | 7 × 10E−7 | 2 |
| Example 1-3 | 1 | 112 | 2.8 | 247 | 0.89 | +2.4 | 6 × 10E−7 | 2 |
| Example 1-4 | 1 | 135 | 3.7 | 251 | 0.89 | +2.3 | 8 × 10E−7 | 2 |
| Example 1-5 | 1 | 109 | 3.2 | 246 | 0.89 | +2.4 | 7 × 10E−7 | 1 |
| Example 1-6 | 2 | 97 | 4.1 | 249 | 0.89 | +2.1 | 8 × 10E−7 | 1 |
| Example 1-7 | 1 | 128 | 4.8 | 251 | 0.89 | +1.0 | 5 × 10E−6 | 3 |
| Example 1-8 | 2 | 85 | 3.9 | 250 | 0.89 | +2.1 | 7 × 10E−7 | 1 |
| Example 1-9 | 1 | 137 | 3.7 | 251 | 0.89 | +2.0 | 6 × 10E−7 | 1 |
| Comp. Ex. 1-1 | 3 | 63 | 3.3 | 248 | 0.89 | −0.1 | 1 × 10E−4 | 3 |
| Comp. Ex. 1-2 | 3 | 74 | 3.4 | 246 | 0.89 | +0.5 | 2 × 10E−5 | 5 |

As will be clear from the results in Table 1, aggregation (orientation aggregation) of ferromagnetic metal particles was improved in Examples 1-1 to 1-9, which contained a resin with a weight average molecular weight (Mw) of equal to or greater than 120,000. In particular, in Examples 1-2 to 1-5, 1-7, and 1-9, in which the weight of binder adsorbing per 1,000 mg of ferromagnetic metal particles exceeded 100 mg, no orientation aggregation was observed whatsoever. This was thought to have occurred because the greater the binder adsorption amount, the greater the stereorepulsive effect acting between ferromagnetic metal particles, and the greater the improvement in orientation aggregation that was achieved.

Marked orientation aggregation was observed in Comparative Examples 1-1 and 1-2. The weight of binder adsorbing per 1,000 mg of ferromagnetic metal particles was less than 80 mg, and orientation aggregation was thought to have occurred due to the low stereorepulsive effect acting between ferromagnetic metal particles.

Examples 1-1 to 1-9 and Comparative Example 1-1 and 1-2 had centerline average surface roughness (Ra) ranging from 2.8 to 4.8 nm.

Better results were achieved for electromagnetic characteristics and the error rate in Examples 1-1 to 1-9 than in Comparative Examples 1-1 and 1-2. The good results achieved by Examples 1-1 to 1-9, in which orientation aggregation was improved, were attributed to a lack of the deterioration in electromagnetic characteristics and the error rate caused by orientation aggregation.

In Examples 1-2 to 1-6, 1-8, and 1-9, in which polyvinyl chloride resin was employed as an additional magnetic layer binder, extremely good results were achieved with regard to dirtying of the magnetic head. In Examples 1-5, 1-6, 1-8, and 1-9, in which polyvinyl chloride resin and a compound comprising thermosetting functional groups were added to the magnetic layer, particularly good results were achieved.

Similar results were achieved in magnetic recording media prepared with magnetic layer coating liquids A to K, in which the solid component concentration of the magnetic layer coating liquid was varied over a range of 10 to 25 weight percent and the coating rate of the magnetic layer coating liquid was varied at above 100 m/min.

Attempts were made to prepare magnetic tape samples of the same magnetic layer thickness as Example 1-1 by the simultaneous multilayer coating method using the nonmagnetic layer coating liquid employed in Example 1-1 and magnetic layer coating liquids A-K, but marked coating striae appeared and it proved difficult to prepare samples the various properties of which could be evaluated. These coating striae were caused by mixing of the nonmagnetic layer and the magnetic layer when the magnetic layer coating liquid was coated while the nonmagnetic layer was still wet (simultaneous multilayer coating). In the simultaneous multilayer coating method, the preparation of a magnetic layer coating liquid yielding high electromagnetic characteristics in a thin film magnetic layer was thought to be difficult because the coating properties were greatly affected by the physical properties of the liquid (concentration and viscosity).

Preparation of Magnetic Recording Medium-2

With the exception that alpha-alumina (Mohs' hardness: 9, average particle diameter: 0.1 micrometer) was replaced with alpha-alumina (Mohs' hardness 9, average particle diameter: 0.15 micrometer) in the magnetic layer coating liquids of Examples 1-1 to 1-9 and Comparative Examples 1-1 and 1-2, magnetic recording media were prepared in identical fashion.

Evaluation of the Magnetic Recording Media

The magnetic recording media prepared were evaluated in the same manner as Examples 1-1 to 1-9 and Comparative Examples 1-1 and 1-2.

Evaluation Results

Magnetic recording media having magnetic layer surfaces with centerline average surface roughness (Ra) values of 3.5 to 6.8 nm were obtained.

Results were obtained indicating the same tendencies as in Examples 1-1 to 1-9 and Comparative Examples 1-1 and 1-2 for aggregation of ferromagnetic metal particles during magnetic orientation, the binder adsorption amount, electromagnetic characteristics, the error rate, and dirtying of the magnetic head.

Although there tended to be some deterioration in electromagnetic characteristics when the centerline average surface roughness (Ra) increased, the electromagnetic characteristics of the magnetic recording media were within an acceptable range. Dirtying of the magnetic head tended to show improvement.

Preparation of Magnetic Recording Medium-3

With the exception that alpha-alumina (Mohs' hardness: 9, average particle diameter: 0.1 micrometer) was replaced with alpha-alumina (Mohs' hardness 9, average particle diameter: 0.2 micrometer) in Examples 1-1 to 1-9 and Comparative Examples 1-1 and 1-2, magnetic recording media were prepared in identical fashion.

Evaluation of the Magnetic Recording Media

The magnetic recording media prepared were evaluated in the same manner as Examples 1-1 to 1-9 and Comparative Examples 1-1 and 1-2.

Evaluation Results

Magnetic recording media having magnetic layer surfaces with centerline average surface roughness (Ra) values of 4.5 to 8.8 nm were obtained.

Results were obtained indicating the same tendencies as in Examples 1-1 to 1-9 and Comparative Examples 1-1 and 1-2 for aggregation of ferromagnetic metal particles during magnetic orientation, the binder adsorption amount, electromagnetic characteristics, the error rate, and dirtying of the magnetic head. Although there tended to be some deterioration in electromagnetic characteristics when the centerline average surface roughness (Ra) increased, the electromagnetic characteristics of the magnetic recording media were within an acceptable range. Dirtying of the magnetic head tended to show improvement.

The present invention permits manufacturing of a magnetic recording medium having excellent electromagnetic characteristics with high productivity.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

Further, when an amount, concentration, or other value or parameter, is given as a list of upper preferable values and lower preferable values, this is to be understood as specifically disclosing all ranges formed from any pair of an upper preferred value and a lower preferred value, regardless whether ranges are separately disclosed.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium comprising a nonmagnetic layer and a magnetic layer in this order on a nonmagnetic support, wherein
the magnetic recording medium is formed by coating a nonmagnetic layer coating liquid on the nonmagnetic support and drying the nonmagnetic layer coating liquid to form the nonmagnetic layer, followed by coating a magnetic layer coating liquid on the nonmagnetic layer and drying the magnetic layer coating liquid to form the magnetic layer, and
the magnetic layer comprises a ferromagnetic powder and a binder and the binder comprises a binder component comprising a constituent component in the form of a resin having a weight average molecular weight, Mw, of equal to or greater than 120,000.

2. The magnetic recording medium of claim 1, wherein the binder component consists of the resin.

3. The magnetic recording medium of claim 1, wherein the binder component is a reaction product of the resin and a compound comprising a thermosetting functional group.

4. The magnetic recording medium of claim 1, wherein the binder component is a reaction product of the resin, a compound comprising a thermosetting functional group and other resin component.

5. The magnetic recording medium of claim 1, wherein the magnetic layer has a thickness ranging from 10 to 300 nm.

6. The magnetic recording medium of claim 1, wherein the magnetic layer comprises the resin in an amount of equal to or greater than 2.5 weight percent relative to the ferromagnetic powder.

7. The magnetic recording medium of claim 1, wherein the resin is a polyurethane resin.

8. The magnetic recording medium of claim 1, wherein the binder further comprises a vinyl chloride resin.

9. The magnetic recording medium of claim 1, wherein the magnetic layer has a centerline average surface roughness, Ra, ranging from 1.0 to 10.0 nm.

10. A method of manufacturing a magnetic recording medium comprising:
coating a nonmagnetic layer coating liquid on a nonmagnetic support and drying the nonmagnetic layer coating liquid to form a nonmagnetic layer, followed by coating a magnetic layer coating liquid on the nonmagnetic layer and drying the magnetic layer coating liquid to form a magnetic layer, wherein
the magnetic layer coating liquid comprises a ferromagnetic powder and a binder and the binder comprises a resin having a weight average molecular weight, Mw, of equal to or greater than 120,000.

11. The method of manufacturing a magnetic recording medium of claim 10, wherein orientation processing is conducted following coating of the magnetic layer coating liquid.

12. The method of manufacturing a magnetic recording medium of claim 10, wherein the magnetic recording medium comprises the resin in an amount of equal to or greater than 2.5 weight percent relative to the ferromagnetic powder.

13. The method of manufacturing a magnetic recording medium of claim 10, wherein the adsorption amount of the binder to the ferromagnetic powder in the magnetic layer coating liquid is equal to or greater than 80 mg per 1000 mg of the ferromagnetic powder.

14. The method of manufacturing a magnetic recording medium of claim 10, wherein the solid component concentration of the magnetic layer coating liquid ranges from 5 to 25 weight percent.

15. The method of manufacturing a magnetic recording medium of claim 10, wherein the coating of the magnetic layer coating liquid is conducted at a coating rate of equal to or higher than 100 m/min.

16. The method of manufacturing a magnetic recording medium of claim 10, wherein the resin is a polyurethane resin.

17. The method of manufacturing a magnetic recording medium of claim 10, wherein the binder further comprises a vinyl chloride resin.

18. The method of manufacturing a magnetic recording medium of claim 10, wherein the binder further comprises a compound comprising a thermosetting functional group.

19. The method of manufacturing a magnetic recording medium of claim 10, wherein the formation of the nonmagnetic layer and the magnetic layer is carried out sequentially on the nonmagnetic support that is fed from a nonmagnetic support stock roll, and following the formation of the nonmagnetic layer and magnetic layer, winding the nonmagnetic support to obtain a magnetic recording medium stock roll, and cutting part of the magnetic recording medium stock roll to obtain a magnetic recording medium in the form of a tape or disk.

20. The method of manufacturing a magnetic recording medium of claim 10, wherein
the formation of the nonmagnetic layer and magnetic layer is carried out on a continuously running nonmagnetic support,
the coating of the magnetic layer coating liquid is carried out by discharging the magnetic layer coating liquid that has been fed into a coating head from a coating slit of the coating head onto the nonmagnetic layer in a quantity in excess of the quantity required to form a magnetic layer of desired thickness while the nonmagnetic layer formed on the nonmagnetic support and a lip surface of the font end of the coating head are in a state of close proximity, and the magnetic layer coating liquid that has been coated in excess is picked up by aspiration through a recovery slit provided downstream from the coating slit as viewed in the running direction of the nonmagnetic support, as well as,
the aspiration is carried out so as to satisfy equation (I) below when the liquid pressure at the aspiration inlet of the recovery slit is denoted as P (MPa):
0.05>P≧0 (I)

21. The method of manufacturing a magnetic recording medium of claim 10, wherein the magnetic layer has a thickness ranging from 10 to 300 nm.

22. The method of manufacturing a magnetic recording medium of claim 10, wherein the magnetic layer has a centerline average surface roughness, Ra, ranging from 1.0 to 10.0 nm.
